(19) United States
(12) Patent Application Publication
(10) Pub. No.: US 2005/0087286 A1
(43) Pub. Date: Apr. 28, 2005

(54) Manufacturing process of a Teflon dual-direction extending film filtration nonwoven (I)

(76) Inventors: Chin Cha Chou, Taiping City (TW); Chin Chun Chou, Taiping City (TW); James Huang, Taiping City (TW); Wen I. Kuo, Taiping City (TW)

Correspondence Address: CHARLES E. BAXLEY, ESQUIRE, Third Floor, 90 John Street, New York, NY, 10038, US

(21) Appl. No.: 10/695,082

(22) Filed: Oct. 28, 2003

(51) Int. Cl. B32B 31/00

(52) U.S. Cl. 156/148

(57) ABSTRACT

The present invention of a manufacturing process of a Teflon dual-direction extending film filtration nonwoven, a dual-direction extending film is film-splitted to become a flock or lint structure, place the processed dual-direction extending film which is in flock or lint structure on the non-processed dual-direction extending film, go through carding process,, after multi-laying, send it to needle-punching machine to needle punch it into a nonwoven of strong structure, then laminate with a layer of Teflon film and process adhere-combining by thermo-heating to become a filtration nonwoven finished product, its manufacturing process is simple and fast.

### BACKGROUND OF THE INVENTION

Conventional manufacturing process of filtration nonwoven uses warp and weft and by knitting to make it as warp and weft net-shape fabric which is made by a top and a bottom layer of cotton. It is then processed by needle-punching, and is combined with a Teflon film by thermo-heating treatment to become a filtration nonwoven.

Conventional warp and weft is made by using film-splitting method to have the nonwoven splitted to become flock or lint (10), then being inter-twisted by an inter-twisting machine to become yam (11). Finally knitted by a knitting machine to become warp and weft net (12). The whole process is very complicated and inconvenient. The warp and weft net will then need to be processed by film-splitting method again to be splitted to become flock or lint, then the warp and weft has to be processed by carding on its top and bottom layers, multi-laying by flock or lint (13), being processed by needle-punching (14), to laminate a Teflon film and adhere-combined by thermo-heating (15) to become a conventional filtration nonwoven (16). It has the disadvantages of complicated and inconvenient manufacturing process.

### SUMMARY OF THE INVENTION

The present invention of manufacturing process of a Teflon dual-direction extending film filtration nonwoven, particularly relates to a process for manufacturing filtration nonwoven with simplified and fast manufacturing process. It applies film-splitting method to split a dual-direction extending film and process it to become flock or lint, then place a layer of flock or lint dual-direction extending film on top of a layer of non-processed dual-direction film by carding process, after process of multi-laying, send it to a needle-punching machine to needle-punch it to become a strong structured nonwoven. Finally laminate it with a Teflon film and adhere-combined by thermo-heating to become a filtration nonwoven. The whole manufacturing process is simple, uncomplicated and fast.

The present invention will become more fully understood by reference to the following detailed description thereof when read in conjunction with the attached drawings

### BRIEF DESCRIPTION OF THE DRAWINGS

FIG. 1 is a manufacturing process flow chart for conventional filtration nonwoven;

FIG. 2 is a manufacturing process flow chart for Teflon dual-direction extending film filtration nonwoven of the present invention;

FIG. 3 a perspective and sectional view of a needle for fabric;

FIG. 4 is a flat view of a needled finished fabric;

FIG. 5 is a flat view of splitting process;

FIG. 6 is a flat view of carding process;

FIG. 7 is a flat view of a needle-punching machine;

FIG. 8 is a flat view of a needle;

FIG. 9 is a flat view of adhere-combining by ultra-sound;

FIG. 10 is a perspective view of filtration nonwoven finished product;

FIG. 11 is a sectional view of filtration nonwoven finished product;

FIG. 12 is a flat view of dry-type nonwoven method;

FIG. 13 is a flat view of wet-type nonwoven method of a first example;

FIG. 14 is a flat view of wet-type nonwoven method of a second example;

FIG. 15 is another embodiment of a manufacturing process flow chart for Teflon dual-direction extending film filtration nonwoven of the present invention;

FIG. 16 is sectional view of multi-layer film of another embodiment of the present invention;

FIG. 17 is combination of perspective, sectional and finished product views of film-splitting method of another embodiment of the present invention;

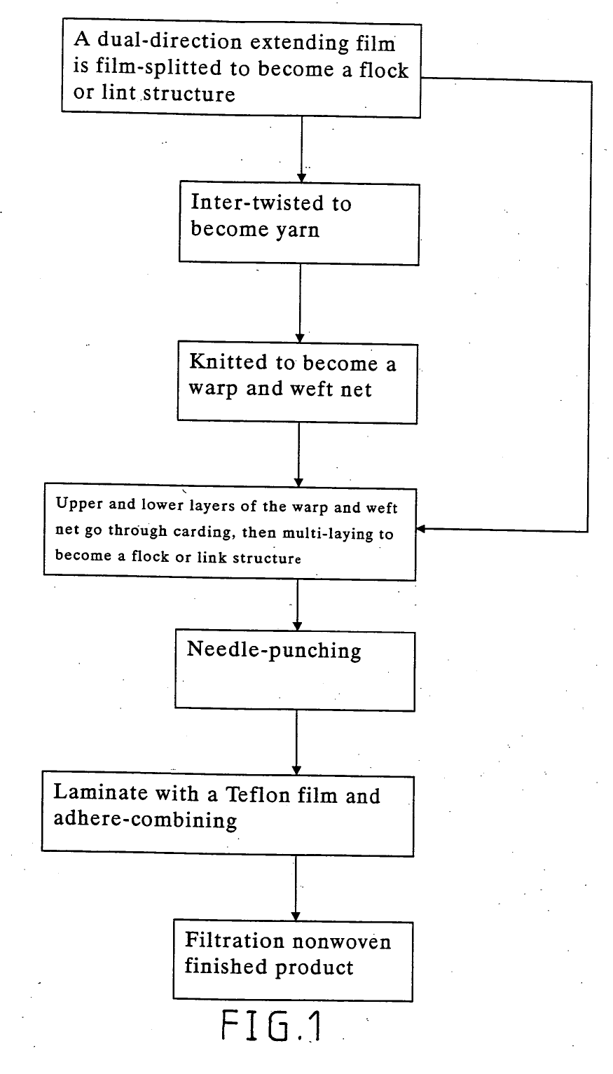

### BRIEF DESCRIPTIONS OF THE INVENTION

The main purpose of the present invention is to tackle the above-mentioned disadvantages. The present invention provides a manufacturing process flow chart for Teflon dual-direction extending film filtration nonwoven, which does not need net-knitting, and can replace a warp and weft with a layer of dual-direction extending film, place one or two layers of carding cotton and flock or lint on the top and bottom of the dual-direction extending film, then laminate with a Telfon film and adhered-combined by thermo-heating. Finally a filtration nonwoven finished product is manufactured. Its manufacturing process is simple and fast.

Another purpose of the present invention is that, can use more than one layer of the extending film in corresponding to the multi-layer flock or lint, then processed by needle-punching and adhere-combining to become a filtration nonwoven.

### DETAILED DESCRIPTION OF THE PREFERRED EMBODIMENT

The present of invention of a manufacturing process for Teflon dual-direction extending film filtration nonwoven. Teflon is a super-high molecular polymerized tetrafluoroethylene (C2F4) raw material. It is specially processed to become a dual-direction extending film, which shown as a composite of fiber and knots under a microscope, if treated with various temperature and times of extending, its fiber and knots show differently. For large times of extending, it does not mean lengthening of fiber, but to split the original knots into fiber and smaller knots. Such splitting creates nano fiber which is the future trend in application of filtration material process. Therefore the present invention has the fiber structure of:

A First Embodiment:

A) A Teflon dual-direction extending film is splitted into a nonwoven flock or lint.

B) Apply needle-punching to combine fiber as the basic material of the Teflon dual-direction extending film and fiber of the nonwoven flock or lint, this combination makes it easier to complete the needle-punching process.

Another Embodiment:

A) Process the Teflon dual-direction extending film into a nano fiber.

1) Processing method for fiber:

Conventional Teflon fiber processing is for single-direction film, the present invention uses Teflon dual-direction extending film, which processed by film-splitting to become nonwoven fiber. As for film thermo-heating treatment, it can apparently affect length and shape of the fiber.

a) If processed with long time and high temperature, the fiber splitted having the main thread and the splitted threads appear to be curly. On the contrary, processed with shorter time and lower temperature, the main thread and splitted threads are less likely to be curly.

b) Based on total extending times, if the horizontal axis having a bigger extending times than that of the vertical axis, the splitted fiber is apparently thinner and longer. Vice versa, if the vertical axis having a bigger extending times than that of the horizontal axis, the splitted fiber is apparently thicker and shorter.

c) It is more suitable and ideal if the angle of upper needle is approximately less than 63 degrees, you can obtain a better splitting result. If the angle is approximately less than 90 degrees, then you get longer fiber with less splitted branch threads.

2) Combine fiber and Teflon film (needle-punched to become nonwoven), then having it splitted to become flock or lint, process it to become evenly thick cotton layer, take it out and place the Teflon dual-direction extending film under it, you can place many layers of film and then it need to be needle-punched. There are several methods:

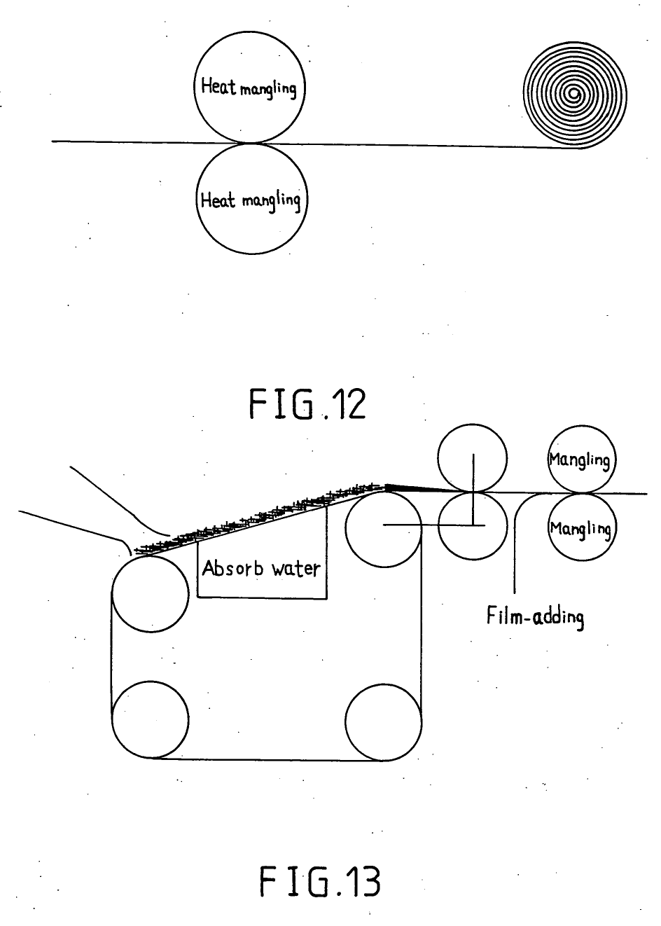

a) Dry-type nonwoven method: because Teflon carries strong negative electricity, during processing, static electricity has to be added to take neutralize the negative electricity. Use blow-type or high-pressure discharge-type can make the fiber easier to be processed (do not let it stick together) (Please refer to FIG. 12).

b) Wet-type nonwoven method: place the splitted flock or lint into liquid and then use a webbing (as shown in FIG. 13) or a netting barrel (as shown in FIG. 14) to fetch it out and processed by mangling and film-adding.

3) Film-Splitting Nonwoven Method:

Teflon dual-direction extending film is extended horizontally and vertically by a special roller blade with a special device. It is extended in many times to lengthen the fiber to its limit.

Teflon is processed and made by ultra-violet light treated yarn, Teflon fiber after being splitted, it is mixed with other materials (such as a certain percentage amount of cotton and artificial fiber), form anti ultra-violet fiber and yarn, which can be knitted to become fabric.

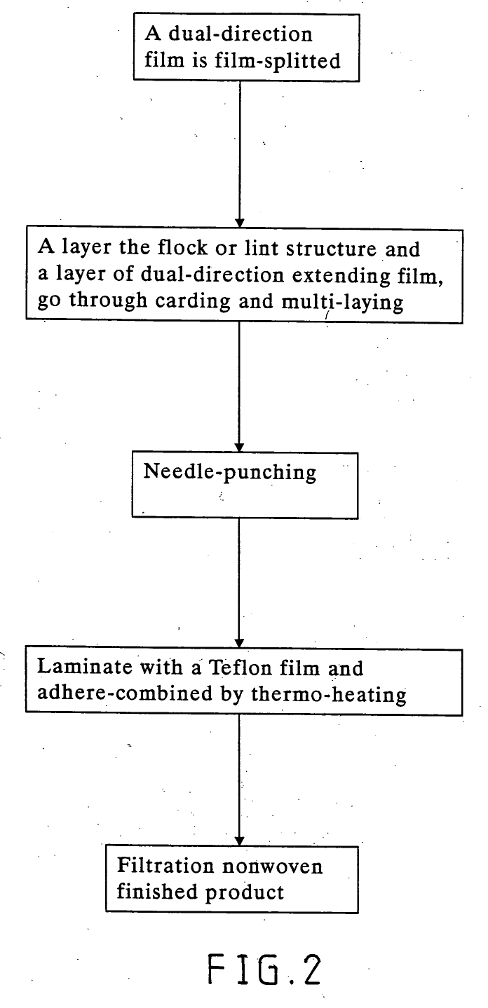

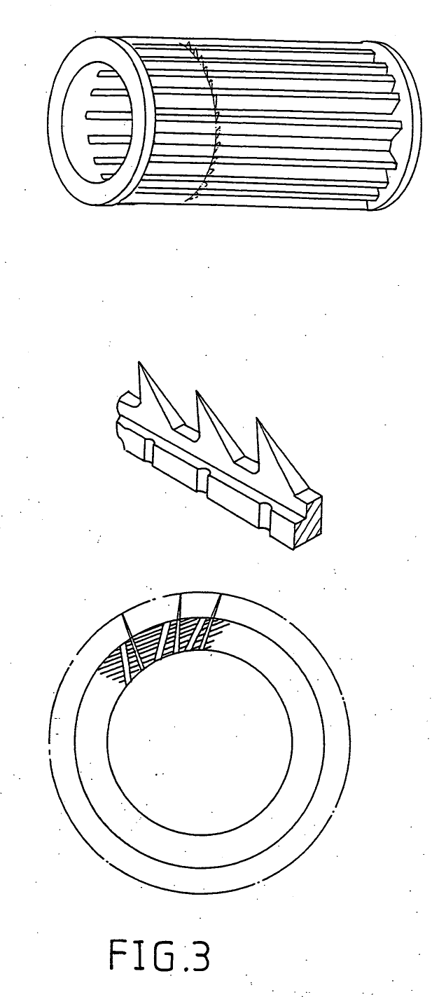

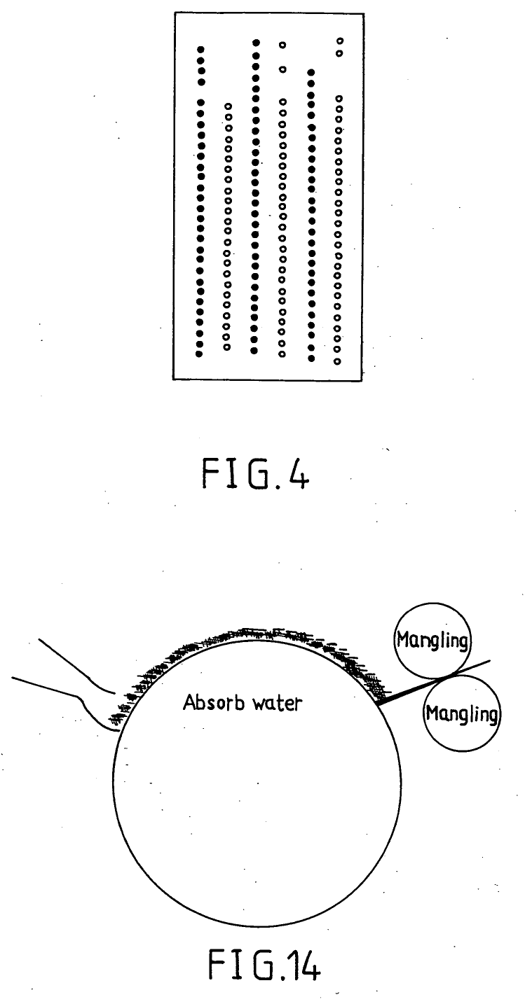

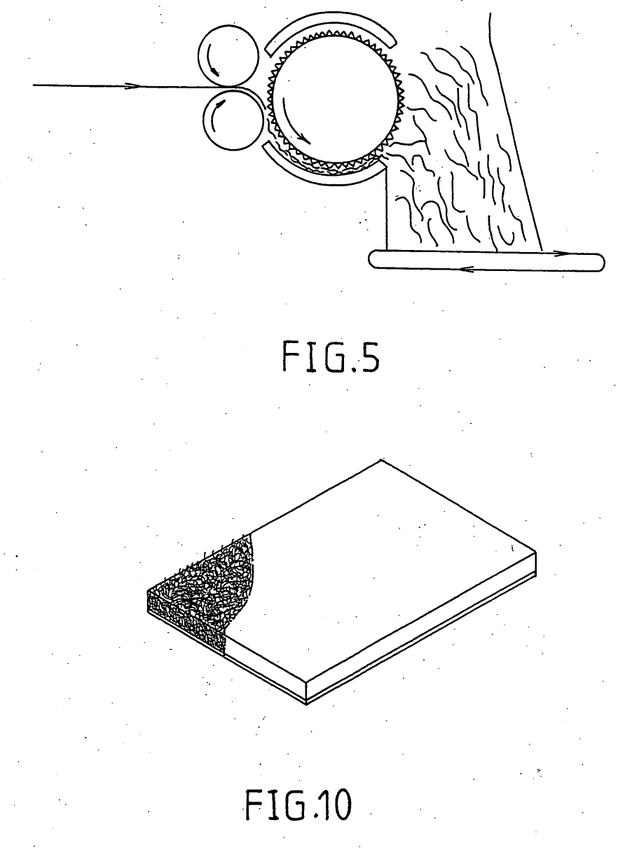

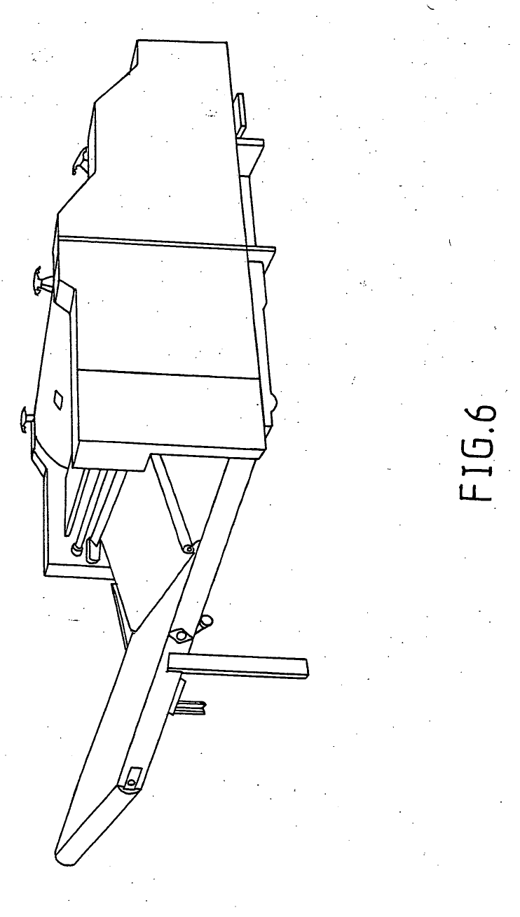

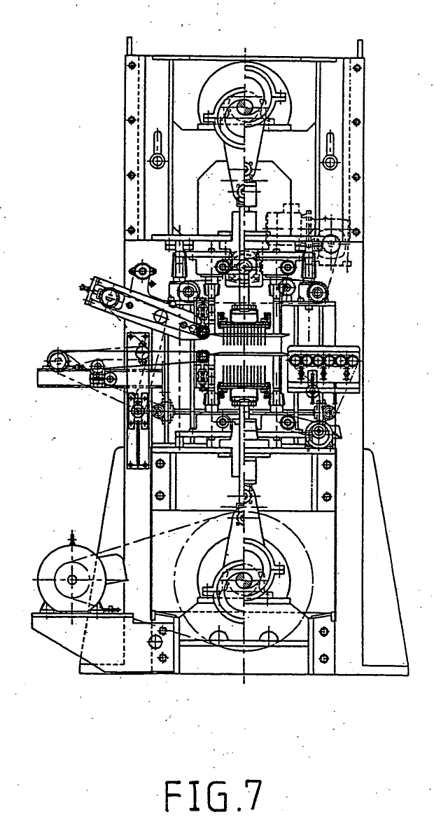

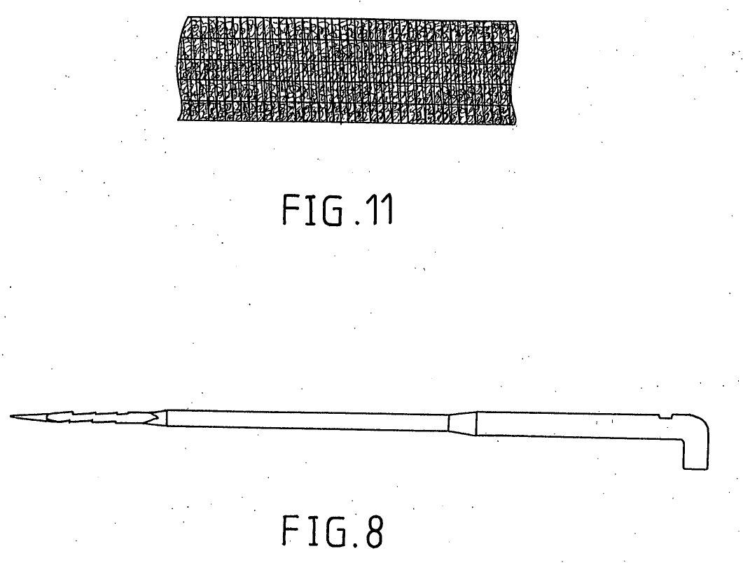

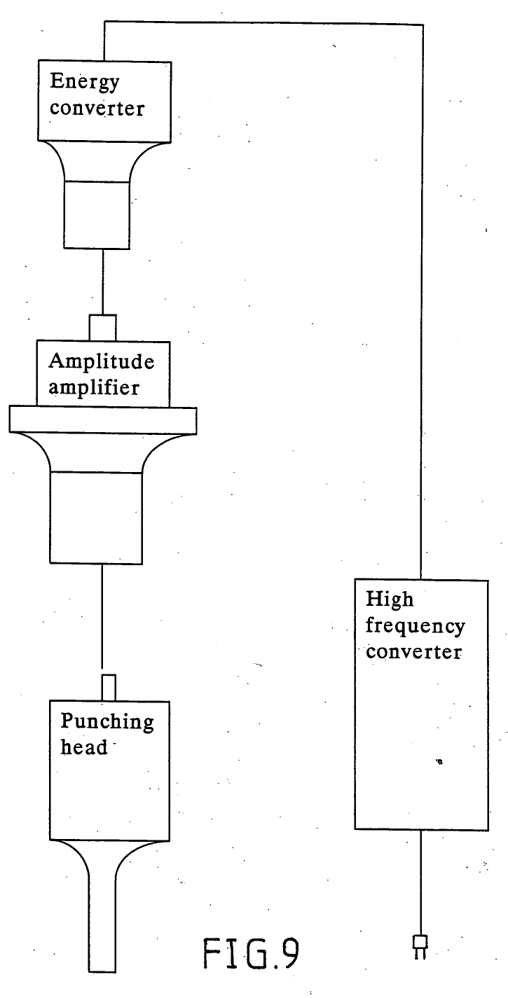

As shown in FIG. 2, a manufacturing process of Teflon filtration nonwoven, with a main purpose of improving conventional manufacturing process of filtration nonwoven which needs manufacturing of warp and weft, the warp and weft has to be knitted to become a net-shape fabric, other procedures including carding, multi-laying, needle-punching, film-adhering and thermo-heating, which are complicated and inconvenient to manufacture. The present invention uses film-splitting (refer to FIGS. 3 and 4), to process splitting (refer to FIG. 5) to become flock or lint (20), add a layer of flock or lint and a layer of dual-direction extending film processed by carding (refer to FIG. 6), multi-laying (21), needle-punching (22) (refer to FIGS. 7 and 8), laminate with Teflon film and adhere-combined by thermo-heating (23), to become a filtration nonwoven finished product (24) (refer to FIGS. 10 and 11). The manufacturing process is more simplified than the conventional.

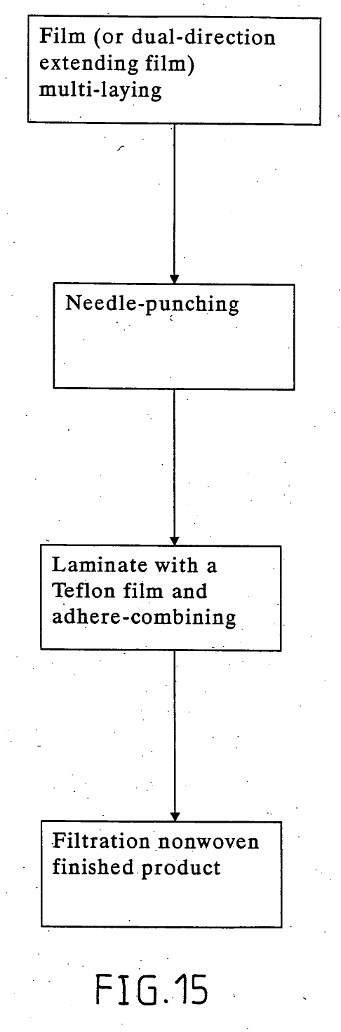

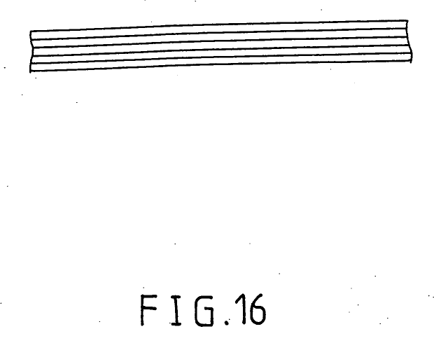

Referring to FIG. 15, which a manufacturing process flow chart of another embodiment of the present invention. It uses film-splitting on a film (or dual-direction extending film) and multi-laying (40) as shown in FIG. 16, apply needle-punching (41) on the multi-layer film (or dual-direction extending film) (refer to FIGS. 7 and 8), laminate with a Teflon film and adhere-combined by thermo-heating (42), to become filtration nonwoven finished product (43) (refer to FIG. 10).

The thermo-heating can use ultrasonic, high cycle wave or adhesive for adhering process.

The needle-punching process uses a needle-punching machine (refer to FIG. 7) having a board with needles, the needle having hooks on its head, which is (refer to FIG. 8) driven by a cam link to move repeatedly on upward and downward directions on a fiber net (multi-laying by machine), the fiber net is very loose in structure, it does not intersect or interweave and is weak in tensility. When thousands of needles are punching through the fiber net, the hooks on the needles will carry some of the fiber through the fiber net, and also because of friction, pressure is applied on the fiber net to make it compress. When the needles go through in a certain depth and move upward, the fiber bundles are released from the hooks and stay inside the fiber net, positioned as almost vertically to the net. So that the compressed fiber net will not go back to its loose structure and with stronger tensility. Its density is increased and it becomes a nonwoven material of strong structure.

As for ultrasonic adhering process as shown in FIG. 9, its principle is to use a high frequency converter (30) to convert the low frequency electric current to high frequency electric current, then it passes through an electric energy converter (31) to convert high frequency electric energy to high frequency mechanical energy, then via a amplitude amplifier (32) and a punching head (33), finally the heat created is transmitted to a fiber net to adhere-combine the fiber net.

The ultrasonic adhering device comprises the following 5 elements:

1) A high frequency converter to convert 50 to 60 Hz electric current to 20K Hz high frequency electric current.

2) An electric energy converter to convert 20K Hz high frequency electric energy to 20K Hz high frequency mechanical energy with 0.02 mm of amplitude.

3) A amplitude amplifier to increase the mechanical amplitude to about 0.1 mm.

4) A punch head to transmit the mechanical energy to the fiber net.

5) A mechanical drill head to support the punching pressure from the fiber net and the punch head.

Advantages of Ultrasonic Adhering Process:

1) High production volume without need of thread knitting, the adhered structure is strong and will not contract as happens in thread knitting which causes damage on the fiber.

2) No heating parts are found on the device, even though there is heat generated from a steel rod and an ultrasonic generator working under high speed, the heat will is absorbed by the material needed to be adhered.

3) In comparing to heat-punch adhering machine, for the same nonwoven with same width and same adhering pictures, ultrasonic adhering device can reach a high speed of 50 m/min, and consumes only ⅔ of energy used by heat-punch adhering machine.

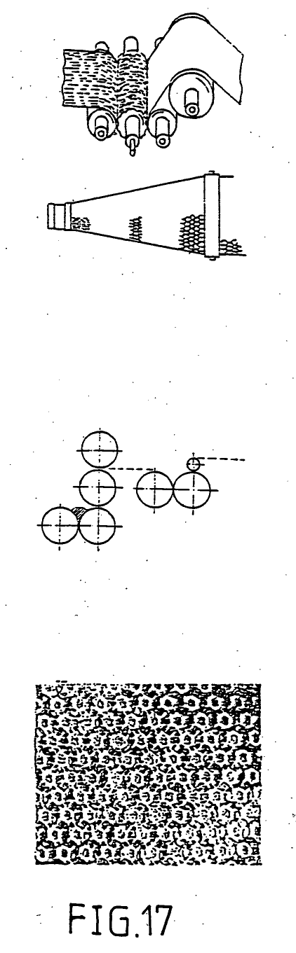

A film-splitting nonwoven as referring to FIG. 17, film-splitting is mainly applied in making plastic film, its principle is to apply pressure on polymer to become film, then processed by pattern punching, tailoring, needle-splitting, and extend it on dual-direction to become fibrous structured film. It can be multi-layered with other nonwoven or by heat-melting process to become nonwoven.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1. A manufacturing process of a Teflon dual-direction extending film filtration nonwoven having process method of,
a dual-direction extending film is splitted to become flock or lint;
a layer of flock or lint and a layer of dual-direction extending film have to be processed by carding and multi-laying;
processed by needle-punching;
laminate with a Teflon film and adhere-combined by thermo-heating, a filtration nonwoven finished product is made.

2. A manufacturing process of a Teflon dual-direction extending film filtration nonwoven as claimed in claim 1, said flock or lint structure is added with a layer of dual-direction extending film, and can be multi-layers.

3. A manufacturing process of a Teflon dual-direction extending film filtration nonwoven as claimed in claim 1, ultrasonic adhering, high cycle wave adhering and adhering by adhesives can be used instead of said thermo-heating for adhered-combining.

4. A manufacturing process of a Teflon dual-direction extending film filtration nonwoven having the following manufacturing processes,
multi-laying of film (or dual-direction extending film);
apply needle-punching;
laminate with a Teflon film, then adhere-combined by thermo-heating, a filtration nonwoven finished product is made.

5. A manufacturing process of a Teflon dual-direction extending film filtration nonwoven as claimed in claim 4, ultrasonic adhering, high cycle wave adhering and adhering by adhesives can be used instead of said thermo-heating for adhered-combining.

6. A manufacturing process of a Teflon dual-direction extending film filtration nonwoven as claimed in claim 4, said film (or dual-direction extending film) can be processed by film-splitting first.
